(19) United States
(12) Patent Application Publication
(10) Pub. No.: US 2026/0145448 A1
(43) Pub. Date: May 28, 2026

(54) PRINTING DEVICE AND CONTROL METHOD OF PRINTING DEVICE

(71) Applicant: SEIKO EPSON CORPORATION, Tokyo (JP)

(72) Inventors: Taishi Sasaki, Shiojiri-shi (JP); Tadashi Inaba, Matsumoto-shi (JP); Tsutomu Yamada, Asahi-mura (JP)

(73) Assignee: SEIKO EPSON CORPORATION, Tokyo (JP)

(21) Appl. No.: 19/397,306

(22) Filed: Nov. 21, 2025

(30) Foreign Application Priority Data
Nov. 22, 2024 (JP) 2024-203926

(51) Int. Cl. B41J 15/04; B41J 3/407; B41J 11/70; B41J 29/13

(52) U.S. Cl. CPC B41J 15/042; B41J 3/4075; B41J 11/703; B41J 15/044; B41J 29/13

(57) ABSTRACT

A printing device includes a cartridge mounting portion on which a tape cartridge configured to accommodate a print tape is mounted, a cover configured to open and close the cartridge mounting portion, a head configured to perform printing on the print tape, a cutting portion configured to cut the printed print tape, and a control portion. The control portion controls a tape transport portion to transport the print tape in an opposite direction over a first transport length when a predetermined condition is satisfied, and to transport the print tape in the opposite direction over a second transport length when the predetermined condition is not satisfied. The first transport length and the second transport length are smaller than a distance from the head to the cutting portion, and the first transport length is larger than the second transport length.

The present application is based on, and claims priority from JP Application Serial Number 2024-203926, filed Nov. 22, 2024, the disclosure of which is hereby incorporated by reference herein in its entirety.

### BACKGROUND

### 1. Technical Field

The present disclosure relates to a printing device and a control method of a printing device.

### 2. Related Art

For example, JP-A-2022-103783 discloses a printing device including a tape transport portion that transports a long print tape from a tape cartridge, a printing portion that performs printing on the print tape, and a cutting portion that cuts the printed print tape. In such a printing device, a margin length of the print tape can be reduced by determining a transport length for transporting the print tape in a reverse direction based on a consumption amount or use time of the print tape.

However, in such a printing device, the length of the print tape that is exposed to the outside from a discharge port of the tape cartridge is not constant. Therefore, a margin is provided in the transport length for transporting the print tape in the reverse direction such that a tip end of the print tape is not accommodated in the tape cartridge. Therefore, it is desired to reduce the margin of the print tape.

### SUMMARY

According to an aspect of the present disclosure, there is provided a printing device including: a cartridge mounting portion on which a tape cartridge configured to accommodate a print tape is mounted; a cover configured to open and close the cartridge mounting portion; a head configured to perform printing on the print tape; a tape transport portion configured to transport the print tape in both a transport direction and an opposite direction to the transport direction; a cutting portion configured to cut the print tape printed by the head; and a control portion, in which the control portion controls the tape transport portion to transport the print tape in the opposite direction over a first transport length when a predetermined condition is satisfied, and controls the tape transport portion to transport the print tape in the opposite direction over a second transport length when the predetermined condition is not satisfied, the first transport length and the second transport length are smaller than a distance from the head to the cutting portion, the first transport length is larger than the second transport length, and the predetermined condition includes a case that a second or subsequent print instruction is given by a user after the cover is closed.

According to another aspect of the present disclosure, there is provided a printing device including: a cartridge mounting portion on which a tape cartridge configured to accommodate a print tape is mounted; a cover configured to open and close the cartridge mounting portion; a head configured to perform printing on the print tape; a tape transport portion configured to transport the print tape in both a transport direction and an opposite direction to the transport direction; a cutting portion configured to cut the print tape printed by the head; and a control portion, in which the control portion controls the tape transport portion to transport the print tape in the opposite direction over a first transport length when a predetermined condition is satisfied, the first transport length is smaller than a distance from the head to the cutting portion, and the predetermined condition includes a case that a second or subsequent print instruction is given by a user after the cover is closed and that a margin length designated by the user is equal to or less than one-third of the distance from the head to the cutting portion.

According to still another aspect of the present disclosure, there is provided a control method of a printing device including a cartridge mounting portion on which a tape cartridge configured to accommodate a print tape is mounted, a cover configured to open and close the cartridge mounting portion, a head configured to perform printing on the print tape, and a cutting portion configured to cut the print tape printed by the head, the method including: transporting the print tape in an opposite direction to a transport direction of the print tape over a first transport length when a predetermined condition is satisfied; and transporting the print tape in the opposite direction over a second transport length when the predetermined condition is not satisfied, in which the first transport length and the second transport length are smaller than a distance from the head to the cutting portion, the first transport length is larger than the second transport length, and the predetermined condition includes a case that a second or subsequent print instruction is given by a user after the cover is closed.

According to still another aspect of the present disclosure, there is provided a control method of a printing device including a cartridge mounting portion on which a tape cartridge configured to accommodate a print tape is mounted, a cover configured to open and close the cartridge mounting portion, a head configured to perform printing on the print tape, and a cutting portion configured to cut the print tape printed by the head, the method including: transporting the print tape in an opposite direction to a transport direction of the print tape over a first transport length when a predetermined condition is satisfied, in which the first transport length is smaller than a distance from the head to the cutting portion, and the predetermined condition includes a case that a second or subsequent print instruction is given by a user after the cover is closed and that a margin length designated by the user is equal to or less than one-third of the distance from the head to the cutting portion.

### BRIEF DESCRIPTION OF THE DRAWINGS

FIG. 1 is a perspective view illustrating a printing device and a tape cartridge according to a first embodiment.

FIG. 2 is a top view illustrating the printing device of the first embodiment.

FIG. 3 is a top view illustrating the printing device of the first embodiment.

FIG. 4 is a flowchart illustrating a reverse transport length setting process of the first embodiment.

### DESCRIPTION OF EMBODIMENTS

### First Embodiment

Hereinafter, an embodiment of a printing device and a control method of the printing device will be described with reference to the drawings. In the following description, in a state in which the printing device is installed on a horizontal surface, an axis intersecting the horizontal surface is set as a Z-axis, an axis intersecting the Z-axis is set as an X-axis, and an axis intersecting the X-axis and the Z-axis is set as a Y-axis. One direction along the X-axis is set as a first width direction X1, and the other direction along the X-axis is set as a second width direction X2. One direction along the Y-axis is set as a forward side Y1, and the other direction along the Y-axis is set as a rearward side Y2. An upward direction along the Z-axis is set as an upward side Z1, and a downward direction along the Z-axis is set as a downward side Z2.

### Configuration of Printing Device 11

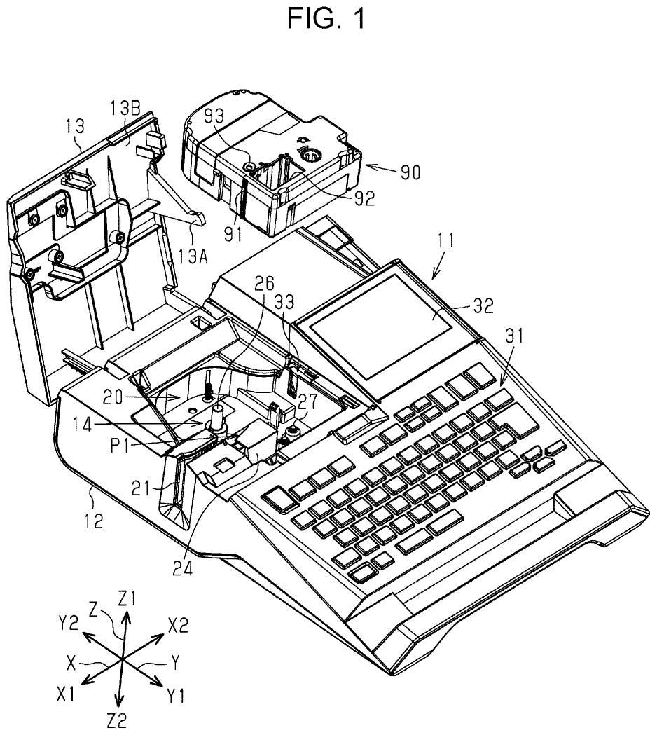

As illustrated in FIG. 1, a printing device 11 is configured to perform printing on a print medium. The print medium may be, for example, a long print tape. A tape cartridge 90 can be mounted on the printing device 11. The printing device 11 is configured to perform printing on the print tape in a state in which the tape cartridge 90 is mounted.

The tape cartridge 90 can accommodate a print tape. The tape cartridge 90 can accommodate a roll-shaped print tape. The tape cartridge 90 accommodates an ink ribbon. The tape cartridge 90 accommodates a roll-shaped ink ribbon.

The tape cartridge 90 is provided with a cartridge discharge port 91. The cartridge discharge port 91 may be provided on a first width direction X1 side of the tape cartridge 90. The cartridge discharge port 91 is configured to discharge the print tape accommodated in the tape cartridge 90.

The tape cartridge 90 includes a head insertion hole 92. The head insertion hole 92 is provided to pass through the tape cartridge 90 along the Z-axis. In a state in which the tape cartridge 90 is mounted on the printing device 11, a head 23 and a head cover 24, which will be described later, are inserted into the head insertion hole 92 toward the upward side Z1.

The tape cartridge 90 includes a platen roller 93. In a state in which the tape cartridge 90 is mounted on the printing device 11, the platen roller 93 is provided at a position facing the head 23.

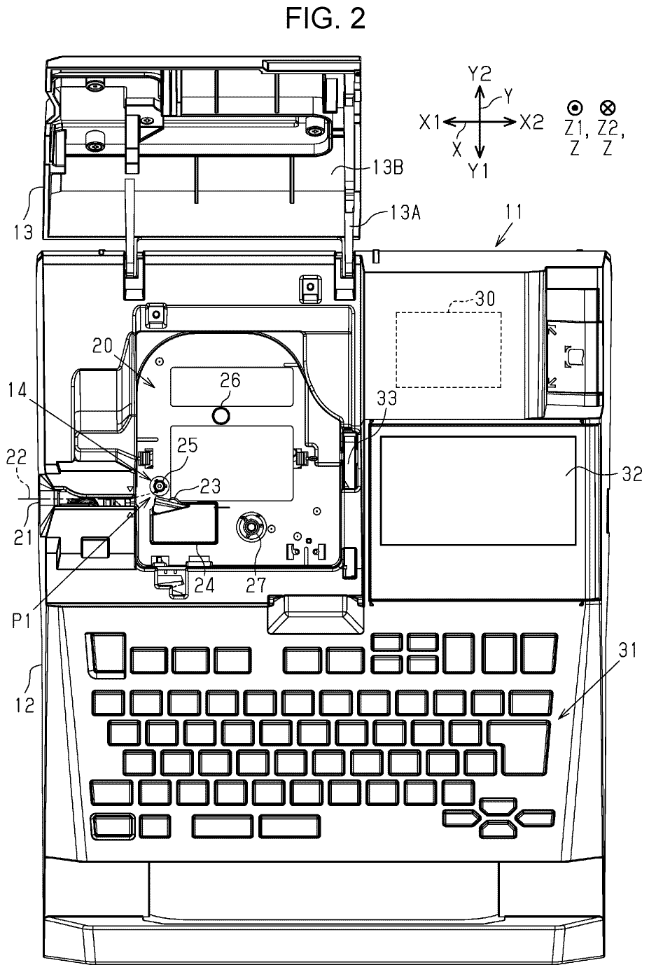

As illustrated in FIGS. 1 and 2, the printing device 11 includes a case 12 and a cover 13. The case 12 is configured to accommodate various members of the printing device 11. The case 12 may have a substantially rectangular parallelepiped shape.

The cover 13 can be opened and closed with respect to the case 12. The cover 13 may be rotatably attached to an end portion of the case 12 on the rearward side Y2. The cover 13 covers the case 12 from the upward side Z1. The cover 13 covers the inside of the case 12.

The cover 13 covers at least a cartridge mounting portion 20 described later. As described above, the cover 13 can open and close the cartridge mounting portion 20. The cover 13 covers the inside of the case 12 in a state in which the tape cartridge 90 is mounted on the cartridge mounting portion 20.

The cover 13 includes a protruding portion 13A. When the cover 13 is closed with respect to the case 12, the protruding portion 13A protrudes from a rear surface 13B of the cover 13 toward the downward side Z2. In a state in which the cover 13 is closed with respect to the case 12, the protruding portion 13A is inserted into an insertion portion 33 to be described later.

The case 12 includes the cartridge mounting portion 20. That is, the printing device 11 includes the cartridge mounting portion 20. The cartridge mounting portion 20 is a recessed portion opened toward the upward side Z1. The tape cartridge 90 is detachable from the cartridge mounting portion 20 toward the upward side Z1. As described above, the tape cartridge 90 can be mounted on the cartridge mounting portion 20. The cartridge mounting portion 20 can accommodate the mounted tape cartridge 90.

The case 12 includes a discharge port 21. That is, the printing device 11 includes the discharge port 21. The discharge port 21 is a portion for discharging a print label from the inside of the printing device 11 to the outside of the printing device 11. The print label is discharged in a state in which the print tape is cut.

As illustrated in FIG. 2, the case 12 includes a transport path 22. The transport path 22 is configured to couple the cartridge mounting portion 20 and the discharge port 21. The transport path 22 is a path through which the print tape is transported from the tape cartridge 90 mounted on the cartridge mounting portion 20 to the discharge port 21. A direction in which the print tape is transported from the tape cartridge 90 toward the discharge port 21 is an example of a transport direction.

The printing device 11 includes the head 23 and the head cover 24. The head 23 and the head cover 24 are provided in the case 12. The head 23 and the head cover 24 are provided in the cartridge mounting portion 20.

The head 23 is configured to perform printing on a print tape. The head 23 may be a thermal head that performs printing on the print medium by using a heat-generating element. The head 23 is provided at a printing position P1. The printing position P1 is a position where the head 23 performs printing on the print medium. The printing position P1 is a position along the transport path 22. The head cover 24 partially covers the head 23.

The printing device 11 includes a tape transport portion 14. The tape transport portion 14 is provided in the case 12. The tape transport portion 14 transports the print tape accommodated in the tape cartridge 90.

The tape transport portion 14 transports the print tape in the transport direction along the transport path 22. The tape transport portion 14 can transport the print tape in an opposite direction to the transport direction along the transport path 22. That is, the tape transport portion 14 can transport the print tape in both the transport direction and the opposite direction to the transport direction. Hereinafter, the opposite direction to the transport direction may be simply referred to as “opposite direction”.

The tape transport portion 14 includes a platen shaft 25. That is, the printing device 11 includes the platen shaft 25. The platen shaft 25 is provided in the case 12. The platen shaft 25 is provided in the cartridge mounting portion 20. The platen shaft 25 is provided to protrude from a bottom surface of the cartridge mounting portion 20 toward the upward side Z1. The platen shaft 25 is a shaft for transmitting power to the platen roller 93 of the tape cartridge 90.

The tape transport portion 14 includes a tape boss portion 26. That is, the printing device 11 includes the tape boss portion 26. The tape boss portion 26 is provided in the case 12. The tape boss portion 26 is provided in the cartridge mounting portion 20. The tape boss portion 26 is provided to protrude from the bottom surface of the cartridge mounting portion 20 toward the upward side Z1. The tape boss portion 26 is a protruding portion for enabling the roll-shaped print tape accommodated in the tape cartridge 90 to be fed.

The tape cartridge 90 is provided with a reverse rotation prevention mechanism (not illustrated). The reverse rotation prevention mechanism is provided in a core around which the print tape is wound in a roll shape. The reverse rotation prevention mechanism functions to prevent the print tape from rotating in the opposite direction, that is, in a winding direction when the tape cartridge 90 is not mounted on the cartridge mounting portion 20.

When the tape cartridge 90 is mounted in the cartridge mounting portion 20, the tape boss portion 26 is inserted into a recessed portion provided in a bottom surface of the tape cartridge 90, and thus the reverse rotation prevention mechanism is released. When the reverse rotation prevention mechanism is released, the print tape can be transported in the transport direction and the opposite direction.

The printing device 11 includes a ribbon winding shaft 27. The ribbon winding shaft 27 is provided in the case 12. The ribbon winding shaft 27 is provided in the cartridge mounting portion 20. The ribbon winding shaft 27 is provided to protrude from the bottom surface of the cartridge mounting portion 20 toward the upward side Z1. The ribbon winding shaft 27 is a shaft for winding an ink ribbon accommodated in the tape cartridge 90.

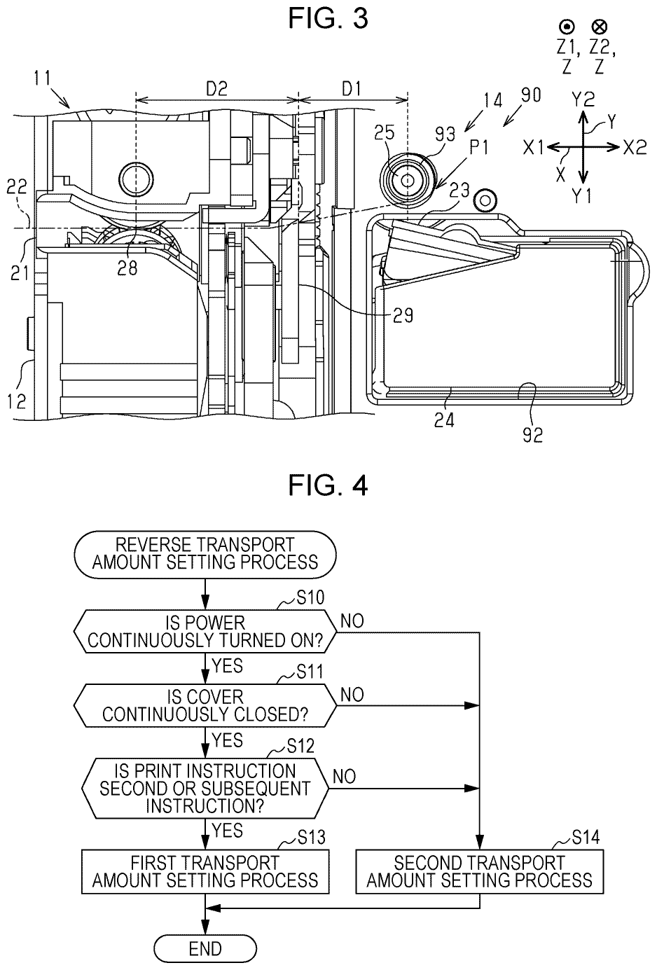

As illustrated in FIG. 3, the tape transport portion 14 includes a discharge roller pair 28. That is, the printing device 11 includes the discharge roller pair 28. The discharge roller pair 28 is provided in the case 12. The discharge roller pair 28 is provided at a position along the transport path 22. The discharge roller pair 28 is provided downstream of the platen shaft 25 and the head 23 in the transport path 22. The discharge roller pair 28 is provided upstream of the discharge port 21. The discharge roller pair 28 is a roller pair for discharging the print tape. The discharge roller pair 28 is a roller pair for discharging a cut print label.

The printing device 11 includes a cutting portion 29. The cutting portion 29 is provided in the case 12. The cutting portion 29 is configured to cut the print tape after printing. The cutting portion 29 is configured to fully cut the print tape. The cutting portion 29 may be a cutter.

The cutting portion 29 is provided at a position along the transport path 22. The cutting portion 29 is provided downstream of the platen shaft 25 and the head 23 in the transport path 22. The cutting portion 29 is provided upstream of the discharge roller pair 28 in the transport path 22.

In the present embodiment, the head 23 and the cutting portion 29 are separated by a first distance D1 in the transport path 22. That is, the first distance D1 is a distance from the head 23 to the cutting portion 29. The cutting portion 29 and the discharge roller pair 28 are separated by a second distance D2 in the transport path 22.

As illustrated in FIG. 2, the printing device 11 includes a control portion 30. The control portion 30 performs overall control of the printing device 11. The control portion 30 controls various operations executed by the printing device 11. The control portion 30 can be configured as a circuit including α: one or more processors that execute various processes according to a computer program, β: one or more dedicated hardware circuits that execute at least some of the various processes, or γ: a combination thereof. The hardware circuit is, for example, an application-specific integrated circuit. The processor includes a CPU and a memory such as a RAM and a ROM, and the memory stores program codes or instructions configured to cause the CPU to execute the processes. A memory, that is, a computer-readable medium includes any readable medium accessible by a general purpose or dedicated computer.

The printing device 11 includes an operation portion 31 and a display portion 32. The operation portion 31 can be operated by a user. The operation portion 31 may be, for example, an operation button. The display portion 32 displays an image. The display portion 32 displays an image related to printing.

The printing device 11 includes the insertion portion 33. The insertion portion 33 is provided in the case 12. The insertion portion 33 is configured to open toward the upward side Z1. When the cover 13 is closed in a state in which the tape cartridge 90 is mounted in the cartridge mounting portion 20, the protruding portion 13A is inserted into the insertion portion 33.

When the protruding portion 13A is inserted into the insertion portion 33, the control portion 30 can recognize opening/closing of the cover 13 based on a detection result from a detection portion (not illustrated). The control portion 30 manages an opening/closing history of the cover 13.

When the protruding portion 13A is inserted into the insertion portion 33, the control portion 30 controls a head moving mechanism (not illustrated) to move the head 23 toward the platen roller 93. As a result, the print tape and the ink ribbon are pinched between the head 23 and the platen roller 93 at a printing position P1.

The control portion 30 inputs an operation signal from the operation portion 31. The control portion 30 causes the display portion 32 to display an image. The control portion 30 can control the head 23. The control portion 30 can control a driving portion (not illustrated) that drives each of the platen shaft 25 and the ribbon winding shaft 27. The driving portion may be a motor. The control portion 30 can control a discharge driving portion (not illustrated) that drives the discharge roller pair 28. The discharge driving portion may be a motor. The control portion 30 can control a cutting driving portion (not illustrated) that drives the cutting portion 29. The cutting driving portion may be a motor.

A print instruction can be input to the control portion 30. The print instruction is input to the control portion 30 in correspondence with an operation of the operation portion 31 by a user. The print instruction may be input to the control portion 30 from a terminal device (not illustrated) communicably connected to the printing device 11. As described above, the printing device 11 may include an information acquisition portion that acquires an instruction from the user. The information acquisition portion may be the operation portion 31, or may be an interface circuit that acquires an instruction given by the user from the terminal device (not illustrated).

The print instruction is data for giving an instruction of printing on the print tape. The print instruction is data corresponding to a print job for one turn. The print job for one turn discharges at least one print label from the print tape. The print instruction includes print data to be printed on the print tape.

The print instruction includes a margin length when performing printing on the print tape. The margin length is provided at both end portions of the print tape in a longitudinal direction. The margin length includes a front margin length in the transport direction and a rear margin length in the opposite direction. The front margin length and the rear margin length may be the same as each other.

The print instruction includes whether or not to perform continuous printing. The print instruction includes the number of sheets to be continuously printed. In the continuous printing, the same image is printed as a plurality of print media. The plurality of print media may be print labels cut from the print tape into a plurality of sheets. As described above, the continuous printing indicates that printing of a plurality of sheets is performed, and the print instruction including the continuous printing is an instruction to perform the printing of the plurality of sheets. The printing device 11 can perform the continuous printing, but may not perform the continuous printing.

When the print instruction is input, the control portion 30 causes the head 23 to generate heat based on print data included in the print instruction. As a result, the control portion 30 performs printing on the print tape by transferring an ink of the ink ribbon to the print tape. In particular, the control portion 30 performs printing on the print tape in correspondence with the margin length included in the print instruction. The control portion 30 performs printing on the print tape as print medium in the number of sheets included in the print instruction.

The control portion 30 drives the tape transport portion 14 to transport the print tape in the transport direction. As a result, a tip end of the print tape accommodated in the tape cartridge 90 is discharged from the cartridge discharge port 91 and is transported along the transport path 22. When the print instruction is input, the control portion 30 drives the ribbon winding shaft 27. As a result, the ink ribbon is wound in the tape cartridge 90.

The control portion 30 controls the cutting portion 29 to cut the print tape at a position corresponding to the margin length included in the print instruction. As a result, the print tape after printing is cut from the print tape before printing and is discharged from the discharge port 21.

In the present embodiment, the control portion 30 can transport the print tape in both the transport direction and the opposite direction by driving the platen shaft 25. In particular, when the print instruction is input, the control portion 30 may transport the print tape in the opposite direction over a predetermined transport length. The predetermined transport length varies depending on whether or not a predetermined condition is satisfied.

### Reverse Transport Amount Setting Process

Here, the reverse transport length setting process will be described with reference to FIG. 4. The reverse transport length setting process is executed by the control portion 30 in response to an input of the print instruction to perform printing to be a defined margin length. The defined margin length may be the shortest margin length among a plurality of margin lengths that can be designated by the user. The defined margin length is equal to or less than one-third of the first distance D1.

As illustrated in FIG. 4, in step S10, the control portion 30 determines whether or not power of the printing device 11 is continuously turned on. When the control portion 30 determines that the power of the printing device 11 is not continuously turned on, the process proceeds to step S14. When the control portion 30 determines that the power of the printing device 11 is continuously turned on, the process proceeds to step S11.

In step S11, the control portion 30 determines whether or not the cover 13 is continuously closed based on the opening/closing history of the cover 13. When the control portion 30 determines that the cover 13 is not continuously closed, the process proceeds to step S14. When the control portion 30 determines that the cover 13 is continuously closed, the process proceeds to step S12.

In step S12, the control portion 30 determines whether or not the print instruction is the second or subsequent print instruction. Specifically, the control portion 30 determines whether or not the print instruction is the second or subsequent print instruction after the power is turned on and the cover 13 is closed.

As a specific example, when the print instruction is input in a state in which the cover 13 is continuously closed after the power is turned on, the control portion 30 determines that the print instruction is not the second or subsequent print instruction. When the second or subsequent print instruction is input in a state in which the cover 13 is continuously closed after the power is turned on, the control portion 30 determines that the print instruction is the second or subsequent print instruction.

When the cover 13 is opened and closed after at least one print instruction is input after the power is turned on with the cover 13 closed, when the print instruction is input, the control portion 30 determines that the print instruction is not the second or subsequent print instruction. When the cover 13 is opened and closed after at least one print instruction is input after the power is turned on with the cover 13 closed, when the second or subsequent print instruction is input, the control portion 30 determines that the print instruction is the second or subsequent print instruction.

When the power is turned off and turned on in this order after at least one print instruction is input after the power is turned on with the cover 13 closed, when the print instruction is input, the control portion 30 determines that the print instruction is not the second or subsequent print instruction. When the power is turned off and turned on in this order after at least one print instruction is input after the power is turned on with the cover 13 closed, when the second or subsequent print instruction is input, the control portion 30 determines that the print instruction is the second or subsequent print instruction.

When the control portion 30 determines that the print instruction is not the second or subsequent print instruction, the process proceeds to step S14. That is, when the control portion 30 determines that the print instruction is a first or subsequent print instruction, the process proceeds to step S14. When the control portion 30 determines that the print instruction is the second or subsequent print instruction, the process proceeds to step S13.

In step S13, the control portion 30 executes the first transport length setting process. In this process, the control portion 30 stores a first transport length in a memory as a transport length for transporting the print tape in an opposite direction to the transport direction. As a result, the control portion 30 sets the first transport length as the transport length for transporting the print tape in the opposite direction to the transport direction.

In step S14, the control portion 30 executes the second transport length setting process. In this process, the control portion 30 stores a second transport length in the memory as a transport length for transporting the print tape in the opposite direction to the transport direction. As a result, the control portion 30 sets the second transport length as the transport length for transporting the print tape in the opposite direction to the transport direction.

The first transport length and the second transport length are smaller than the first distance D1. The first transport length is larger than the second transport length. The first transport length is a transport length corresponding to a margin length designated by a user. The first transport length may be equal to or more than two-thirds of the first distance D1. The second transport length may be less than two-thirds of the first distance D1 and may be equal to or more than one-half of the first distance D1. For example, when the first distance D1 is 9 mm, the first transport length may be 8 mm and the second transport length may be 5 mm when the margin length designated by the user is 1 mm.

As described above, the control portion 30 controls the tape transport portion 14 to transport the print tape in the opposite direction over the first transport length when a predetermined condition is satisfied in response to the input of the print instruction. When the predetermined condition is not satisfied, the control portion 30 controls the tape transport portion 14 to transport the print tape in the opposite direction over the second transport length in response to the input of the print instruction.

The predetermined condition includes a case that the margin length designated by the user is equal to or less than one-third of the first distance D1. The predetermined condition includes a case that the second or subsequent print instruction is given by the user in a state in which the power is turned on and the cover 13 is continuously closed.

As described above, the predetermined condition may include a case that the second or subsequent print instruction is given by the user when the tape cartridge 90 is continuously mounted on the cartridge mounting portion 20. That is, the control portion 30 determines that the tape cartridge 90 is continuously mounted on the cartridge mounting portion 20 when the cover 13 is continuously closed after the power is turned on. The control portion 30 determines that the predetermined condition is satisfied when the second or subsequent print instruction is given by the user after the tape cartridge 90 is mounted on the cartridge mounting portion 20.

### Operation and Effect of First Embodiment

The operation and effect of the first embodiment will be described.

1-1. The control portion 30 causes the print tape to be transported in the opposite direction over the first transport length when the predetermined condition is satisfied, and causes the print tape to be transported in the opposite direction over the second transport length when the predetermined condition is not satisfied. The first transport length and the second transport length are smaller than a distance from the head 23 to the cutting portion 29, and the first transport length is larger than the second transport length. The predetermined condition includes a case that the second or subsequent print instruction is given by the user after the cover 13 is closed.

According to this configuration, when the predetermined condition including a case that the second or subsequent print instruction is given by the user after the cover 13 is closed is satisfied, the print tape can be transported in the opposite direction over the first transport length larger than the second transport length. In the second or subsequent print instruction after the cover 13 is closed, there is a high possibility that a state in which the print tape is cut in the first print instruction after the cover 13 is closed is maintained. Therefore, the length of the print tape discharged from the tape cartridge 90 is highly likely to be the length up to the cutting portion 29. As a result, even when a tape detection portion that detects the tip end of the print tape is not provided, the tip end of the print tape is not accommodated in the tape cartridge 90, and the print tape can be transported in the opposite direction over the first transport length. Therefore, the margin of the print tape can be reduced.

Even when the predetermined condition is not satisfied, the print tape can be transported in the opposite direction over the second transport length smaller than the first transport length without discharging the unprinted print label. Therefore, the margin of the print tape can be reduced.

1-2. The predetermined condition includes a case that the margin length designated by the user is equal to or less than one-third of the first distance D1. According to this configuration, even when the margin length designated by the user is equal to or less than one-third of the first distance D1, the tip end of the print tape is not accommodated in the tape cartridge 90, and the print tape can be transported in the opposite direction over the first transport length. Therefore, the margin of the print tape can be reduced.

1-3. The predetermined condition includes a case that the second or subsequent print instruction is given by the user in a state in which the power is turned on and the cover 13 is continuously closed. In a state where the power is turned on and the cover 13 is continuously closed, in the second or subsequent print instruction given by the user, there is a high possibility that a state in which the print tape is cut in the first print instruction is maintained. Therefore, even when the tape detection portion that detects the tip end of the print tape is not provided, when the predetermined condition is satisfied, the tip end of the print tape is not accommodated in the tape cartridge 90, and the print tape can be transported in the opposite direction over the first transport length larger than the second transport length. Therefore, the margin of the print tape can be reduced.

### Second Embodiment

Next, a second embodiment will be described. In the following description, redundant description of the same configurations as those in the embodiment already described will be omitted or simplified, and configurations different from those in the embodiment already described will be described.

In the second embodiment, in step S14 of FIG. 4, the control portion 30 may set the second transport length to 0. That is, the control portion 30 may not cause the print tape to be transported in the opposite direction when the predetermined condition is not satisfied.

In such a case, the control portion 30 may cause the print tape to be transported in the transport direction, may cause the cutting portion 29 to cut the print tape such that the print tape has a margin length designated by the user, and may cause the head 23 to perform printing on the print tape.

Specifically, the control portion 30 controls the cutting portion 29 to cut the print tape after the tip end of the print tape reaches the discharge roller pair 28 along the transport path 22. The control portion 30 causes the head 23 to perform printing on the print tape such that the margin length is a margin length designated by the user from a position where the print tape is cut by the cutting portion 29.

As a specific example, when the predetermined condition is not satisfied, the control portion 30 may perform control such that the print tape is transported over a total distance of the first distance D1 and the second distance D2 and then the cutting portion 29 cuts the print tape.

When the predetermined condition is not satisfied, the control portion 30 may cause the head 23 to start printing of the print tape after the print tape is transported over a total distance of the second distance D2 and the margin length. As a result, when the predetermined condition is not satisfied, one print label that is not printed is discharged, and the margin length designated by the user can be realized without transporting the print tape in the opposite direction.

### Operation and Effect of Second Embodiment

The operation and effect of the second embodiment will be described.

2-1. The control portion 30 causes the print tape to be transported in the transport direction without being transported in the opposite direction when the predetermined condition is not satisfied. The control portion 30 causes the cutting portion 29 to cut the print tape to have a margin length designated by the user. According to this configuration, even when the predetermined condition is not satisfied, printing with a margin length that is equal to or less than one-third of the distance from the head 23 to the cutting portion 29 can be realized without transporting the print tape in the opposite direction.

### Modification Example

The present embodiment can be modified and implemented as follows. The present embodiment and the following modification example can be implemented in combination with each other in a technically consistent range.

The control portion 30 can execute various processes and various determinations in any order in a technically consistent range. The control portion 30 can execute a plurality of processes as one process. The control portion 30 can execute one process as a plurality of processes. The control portion 30 can execute one determination as a plurality of determinations. The control portion 30 can execute a plurality of determinations as one determination.

When the predetermined condition is not satisfied, the control portion 30 may give a notification that the predetermined condition is not satisfied. When the predetermined condition is not satisfied, the control portion 30 may give a notification that a margin length is not the margin length designated by the user.

When the predetermined condition is not satisfied, the control portion 30 may give a notification of whether or not to perform printing. In such a case, the control portion 30 may perform printing in correspondence with a permission instruction from a user. The control portion 30 may stop printing in correspondence with a stop instruction from the user.

The control portion 30 may give various notifications. The control portion 30 may give various notifications by displaying an image on the display portion 32. The control portion 30 may give various notifications by outputting a notification sound from a speaker (not illustrated). The control portion 30 may give various notifications by causing a light-emitting portion (not illustrated) to emit light in a predetermined light-emitting mode. The control portion 30 may give various notifications by transmitting notification data to a terminal device (not illustrated).

In the first embodiment, when the predetermined condition is not satisfied, the control portion 30 may cause the cutting portion 29 to cut a tip end side of the first print label to be printed. As a result, although a non-printed print label is discharged, a margin length of the first print label can be accurately realized.

In the second embodiment, when the predetermined condition is not satisfied, the control portion 30 may not cause the cutting portion 29 to cut the tip end side of the first print label to be printed. As a result, the non-printed print label is not discharged.

In the second embodiment, when the predetermined condition is not satisfied, the control portion 30 may cause the head 23 to start printing on the print tape after the print tape is transported in the transport direction over the margin length designated by the user. When the predetermined condition is not satisfied, the control portion 30 may start the transport of the print tape in the transport direction after causing the head 23 to start printing on the print tape.

The predetermined condition may not include at least any one of a plurality of conditions. The predetermined condition may include another condition other than the plurality of conditions. For example, another condition may include a case that a predetermined time has elapsed.

The predetermined condition may include a case that the print instruction is not an instruction to perform continuous printing. That is, the predetermined condition may include a case that the print instruction given by the user is not an instruction to perform continuous printing. As described above, the control portion 30 may set the transport length of the print tape transported in the opposite direction as the first transport length when the print instruction is not the print instruction to perform the continuous printing based on the print instruction.

The predetermined condition may not include whether or not the power is turned on. For example, the predetermined condition may include a case that a second or subsequent print instruction is given by the user after the cover 13 is closed regardless of whether or not the power is turned on. As described above, the control portion 30 may set the transport length of the print tape transported in the opposite direction as the first transport length regardless of whether or not the power is turned on.

The first distance D1 and the second distance D2 may be any value. The first transport length and the second transport length may be any amount as long as the first transport length is smaller than the first distance D1 and the first transport length is larger than the second transport length. For example, when the first distance D1 is 9 mm, the first transport length may be 6 mm when the margin length is 3 mm.

The number of margin lengths that can be designated by the user may be any number. The margin length that can be designated by the user may be any value. A plurality of margin lengths that can be designated by the user may include a defined margin length and a margin length other than the defined margin length.

The defined margin length may be any value. A plurality of the defined margin lengths may be provided. The defined margin length may include a margin length that is not the shortest among the plurality of margin lengths. The defined margin length may include a margin length that is greater than one-third of the first distance D1 and is equal to or less than one-half of the first distance D1. That is, the predetermined condition may include a case that the margin length designated by the user is greater than one-third of the first distance D1 and is equal to or less than one-half of the first distance D1.

The second transport length is set in advance as a transport length for transporting the print tape in the opposite direction, and the control portion 30 may change the transport length for transporting the print tape in the opposite direction from the second transport length to the first transport length in step S13 when a predetermined condition is satisfied. In this case, the control portion 30 may not execute step S14 when the predetermined condition is not satisfied.

The first transport length is set in advance as a transport length for transporting the print tape in the opposite direction, and the control portion 30 may change the transport length for transporting the print tape in the opposite direction from the first transport length to the second transport length in step S14 when the predetermined condition is not satisfied. In this case, the control portion 30 may not execute step S13 when the predetermined condition is satisfied.

The printing device 11 may include a second cutting portion that half-cuts the print tape separately from the cutting portion 29. The second cutting portion is provided at a position along the transport path 22. In this case, the cutting portion 29 may be a first cutting portion that fully cuts the print tape. The second cutting portion may be provided downstream of the cutting portion 29, or may be provided upstream of the cutting portion 29.

The printing device 11 may include the platen roller 93 itself. The tape cartridge 90 may not include the platen roller 93, and may include a platen roller insertion hole. The platen roller insertion hole is a hole through which the platen roller 93 can be inserted. When the tape cartridge 90 is mounted on the cartridge mounting portion 20, the platen roller 93 is inserted into the platen roller insertion hole.

The printing device 11 may be configured to introduce a long print tape from the outside. In such a case, the print tape is introduced into the tape cartridge 90 from the outside of the printing device 11.

The expression “at least any one” used in the present specification means one or more of desired options. As an example, the expression “at least any one” used in the present specification means only one option or both of two options when the number of options is two. In another example, the expression “at least any one” used in the present specification means only one option or a combination of any two or more options when the number of options is three or more.

### Additional Notes

Hereinafter, the technical ideas and the operation and effect understood from the above-described embodiment and modification example will be described. The technical ideas and the operation and effect thereof can be combined with each other in a technically consistent range.

[1] A printing device including: a cartridge mounting portion on which a tape cartridge configured to accommodate a print tape is mounted; a cover configured to open and close the cartridge mounting portion; a head configured to perform printing on the print tape; a tape transport portion configured to transport the print tape in both a transport direction and an opposite direction to the transport direction; a cutting portion configured to cut the print tape printed by the head; and a control portion, in which the control portion controls the tape transport portion to transport the print tape in the opposite direction over a first transport length when a predetermined condition is satisfied, and controls the tape transport portion to transport the print tape in the opposite direction over a second transport length when the predetermined condition is not satisfied, the first transport length and the second transport length are smaller than a distance from the head to the cutting portion, the first transport length is larger than the second transport length, and the predetermined condition includes a case that a second or subsequent print instruction is given by a user after the cover is closed.

According to this configuration, when the predetermined condition including a case that the second or subsequent print instruction is given by the user after the cover is closed is satisfied, the print tape can be transported in the opposite direction over the first transport length larger than the second transport length. In the second or subsequent print instruction after the cover is closed, there is a high possibility that a state in which the print tape is cut in the first print instruction after the cover is closed is maintained. Therefore, the length of the print tape discharged from the tape cartridge is highly likely to be the length up to the cutting portion. As a result, even when the tape detection portion that detects a tip end of the print tape is not provided, the tip end of the print tape is not accommodated in the tape cartridge, and the print tape can be transported in the opposite direction over the first transport length. Therefore, the margin of the print tape can be reduced.

Even when the predetermined condition is not satisfied, the print tape can be transported in the opposite direction over the second transport length smaller than the first transport length. Therefore, the margin of the print tape can be reduced.

[2] In the printing device, the predetermined condition may further include a case that a margin length designated by the user is equal to or less than one-third of the distance from the head to the cutting portion.

According to this configuration, even when the margin length designated by the user is equal to or less than one-third of the distance from the head to the cutting portion, the tip end of the print tape is not accommodated in the tape cartridge, and the print tape can be transported in the opposite direction over the first transport length. Therefore, the margin of the print tape can be reduced.

[3] A printing device including: a cartridge mounting portion on which a tape cartridge configured to accommodate a print tape is mounted; a cover configured to open and close the cartridge mounting portion; a head configured to perform printing on the print tape; a tape transport portion configured to transport the print tape in both a transport direction and an opposite direction to the transport direction; a cutting portion configured to cut the print tape printed by the head; and a control portion, in which the control portion controls the tape transport portion to transport the print tape in the opposite direction over a first transport length when a predetermined condition is satisfied, the first transport length is smaller than a distance from the head to the cutting portion, and the predetermined condition includes a case that a second or subsequent print instruction is given by a user after the cover is closed and that a margin length designated by the user is equal to or less than one-third of the distance from the head to the cutting portion.

According to this configuration, when the predetermined condition including a case that the second or subsequent print instruction is given by the user after the cover is closed is satisfied, the print tape can be transported in the opposite direction over the first transport length. In the second or subsequent print instruction after the cover is closed, there is a high possibility that a state in which the print tape is cut in the first print instruction after the cover is closed is maintained. Therefore, the length of the print tape discharged from the tape cartridge is highly likely to be the length up to the cutting portion. As a result, even when the tape detection portion that detects a tip end of the print tape is not provided, the tip end of the print tape is not accommodated in the tape cartridge, and the print tape can be transported in the opposite direction over the first transport length. In addition, even when a margin length designated by the user is equal to or less than one-third of the distance from the head to the cutting portion, the tip end of the print tape is not accommodated in the tape cartridge, and the print tape can be transported in the opposite direction over the first transport length. Therefore, the margin of the print tape can be reduced.

[4] In the printing device, the control portion may cause the print tape to be transported in the transport direction without being transported in the opposite direction when the predetermined condition is not satisfied, and may cause the cutting portion to cut the print tape to have the margin length designated by the user.

According to this configuration, even when the predetermined condition is not satisfied, printing with a margin length that is equal to or less than one-third of the distance from the head to the cutting portion can be realized without transporting the print tape in the opposite direction.

[5] In the printing device, the predetermined condition may include a case that the second or subsequent print instruction is given by the user in a state in which power is turned on and the cover is continuously closed.

According to this configuration, in a state in which the power is turned on and the cover is continuously closed, in the second or subsequent print instruction given by the user, there is a high possibility that a state in which the print tape is cut in the first print instruction is maintained. Therefore, even when the tape detection portion that detects the tip end of the print tape is not provided, when the predetermined condition is satisfied, the tip end of the print tape is not accommodated in the tape cartridge, and the print tape can be transported in the opposite direction over the first transport length larger than the second transport length. Therefore, the margin of the print tape can be reduced.

[6] A control method of a printing device including a cartridge mounting portion on which a tape cartridge configured to accommodate a print tape is mounted, a cover configured to open and close the cartridge mounting portion, a head configured to perform printing on the print tape, and a cutting portion configured to cut the print tape printed by the head, the method including: transporting the print tape in an opposite direction to a transport direction of the print tape over a first transport length when a predetermined condition is satisfied; and transporting the print tape in the opposite direction over a second transport length when the predetermined condition is not satisfied, in which the first transport length and the second transport length are smaller than a distance from the head to the cutting portion, the first transport length is larger than the second transport length, and the predetermined condition includes a case that a second or subsequent print instruction is given by a user after the cover is closed. According to this configuration, the same effect as in [1] is achieved.

[7] A control method of a printing device including a cartridge mounting portion on which a tape cartridge configured to accommodate a print tape is mounted, a cover configured to open and close the cartridge mounting portion, a head configured to perform printing on the print tape, and a cutting portion configured to cut the print tape printed by the head, the method including: transporting the print tape in an opposite direction to a transport direction of the print tape over a first transport length when a predetermined condition is satisfied, in which the first transport length is smaller than a distance from the head to the cutting portion, and the predetermined condition includes a case that a second or subsequent print instruction is given by a user after the cover is closed and that a margin length designated by the user is equal to or less than one-third of the distance from the head to the cutting portion. According to this configuration, the same effect as in [3] is achieved.

What is claimed is:

1. A printing device comprising:
a cartridge mounting portion on which a tape cartridge configured to accommodate a print tape is mounted;
a cover configured to open and close the cartridge mounting portion;
a head configured to perform printing on the print tape;
a tape transport portion configured to transport the print tape in both a transport direction and an opposite direction to the transport direction;
a cutting portion configured to cut the print tape printed by the head; and
a control portion, wherein
the control portion controls the tape transport portion to transport the print tape in the opposite direction over a first transport length when a predetermined condition is satisfied, and controls the tape transport portion to transport the print tape in the opposite direction over a second transport length when the predetermined condition is not satisfied,
the first transport length and the second transport length are smaller than a distance from the head to the cutting portion,
the first transport length is larger than the second transport length, and
the predetermined condition includes a case that a second or subsequent print instruction is given by a user after the cover is closed.

2. The printing device according to claim 1, wherein
the predetermined condition further includes a case that a margin length designated by the user is equal to or less than one-third of the distance from the head to the cutting portion.

3. A printing device comprising:
a cartridge mounting portion on which a tape cartridge configured to accommodate a print tape is mounted;
a cover configured to open and close the cartridge mounting portion;
a head configured to perform printing on the print tape;
a tape transport portion configured to transport the print tape in both a transport direction and an opposite direction to the transport direction;
a cutting portion configured to cut the print tape printed by the head; and
a control portion, wherein
the control portion controls the tape transport portion to transport the print tape in the opposite direction over a first transport length when a predetermined condition is satisfied,
the first transport length is smaller than a distance from the head to the cutting portion, and
the predetermined condition includes a case that a second or subsequent print instruction is given by a user after the cover is closed and that a margin length designated by the user is equal to or less than one-third of the distance from the head to the cutting portion.

4. The printing device according to claim 3, wherein
the control portion causes the print tape to be transported in the transport direction without being transported in the opposite direction when the predetermined condition is not satisfied, and causes the cutting portion to cut the print tape to have the margin length designated by the user.

5. The printing device according to claim 1, wherein
the predetermined condition includes a case that the second or subsequent print instruction is given by the user in a state in which power is turned on and the cover is continuously closed.

6. A control method of a printing device including a cartridge mounting portion on which a tape cartridge configured to accommodate a print tape is mounted, a cover configured to open and close the cartridge mounting portion, a head configured to perform printing on the print tape, and a cutting portion configured to cut the print tape printed by the head, the method comprising:
transporting the print tape in an opposite direction to a transport direction of the print tape over a first transport length when a predetermined condition is satisfied; and
transporting the print tape in the opposite direction over a second transport length when the predetermined condition is not satisfied, wherein
the first transport length and the second transport length are smaller than a distance from the head to the cutting portion,
the first transport length is larger than the second transport length, and
the predetermined condition includes a case that a second or subsequent print instruction is given by a user after the cover is closed.

7. A control method of a printing device including a cartridge mounting portion on which a tape cartridge configured to accommodate a print tape is mounted, a cover configured to open and close the cartridge mounting portion, a head configured to perform printing on the print tape, and a cutting portion configured to cut the print tape printed by the head, the method comprising:
transporting the print tape in an opposite direction to a transport direction of the print tape over a first transport length when a predetermined condition is satisfied, wherein
the first transport length is smaller than a distance from the head to the cutting portion, and
the predetermined condition includes a case that a second or subsequent print instruction is given by a user after the cover is closed and that a margin length designated by the user is equal to or less than one-third of the distance from the head to the cutting portion.
